(19) United States
(12) Patent Application Publication
(10) Pub. No.: US 2004/0134259 A1
(43) Pub. Date: Jul. 15, 2004

(54) Method for leak testing of electrochemical elements

(75) Inventors: Peter Haug, Ellwangen (DE); Peter Birke, Ellwangen (DE); Rainer Hald, Ellwangen (DE); Konrad Holl, Aalen-Dewangen (DE); Dejan Ilic, Ellwangen (DE)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: VARTA Microbattery GmbH, a corporation of Germany, Hannover (DE)

(21) Appl. No.: 10/729,316

(22) Filed: Dec. 5, 2003

(30) Foreign Application Priority Data
Jan. 13, 2003 (DE) 103 01 430.6

(51) Int. Cl. G01M 3/36

(52) U.S. Cl. 73/40

(57) ABSTRACT

In a method for leak testing of electrochemical elements which have a thin flexible housing that is composed of a metal sheet or a metal/plastic composite sheet, after assembly and if necessary after formation in a closed container, the electrochemical element is subjected to an increased pressure and then to a reduced pressure, and any change in thickness that occurs is measured. Alternatively, after assembly, formation and storage in a closed container, the electrochemical element is subjected to a reduced pressure, and any change in thickness that occurs is measured.

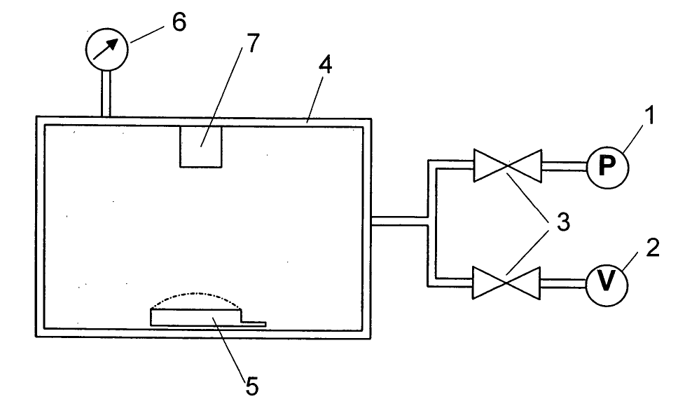

### RELATED APPLICATION

This application claims priority of German Patent Application No. 103 01 430.6, filed Jan. 13, 2003.

### FIELD OF THE INVENTION

This invention relates to a method for leak testing of electrochemical elements which have a thin flexible housing that is composed of a metal sheet or a metal/plastic composite sheet.

### BACKGROUND

Portable appliances such as PDAs, organizers, laptops or cellular phones require rechargeable energy stores with ever greater volumetric and gravimetric energy densities. The size and weight of the housings of the electrochemical elements for applications such as these have an ever greater influence on the energy density of the elements. A light and very flexible metal/plastic composite sheet is therefore used as the housing material for elements such as these, instead of the conventional heavy and robust cups, which are generally composed of nickel-plated stainless steel or aluminium. Aluminium/plastic composite sheets are used in particular.

In order that this flexible composite sheet rests closely against the inner cell components, it is vacuum-packed, that is to say, a defined reduced pressure is applied before the composite sheet is finally closed, and only then is the composite sheet that encloses the cell components closed in a gastight manner by means of a sealing process. The metal/plastic composite sheet is then firmly pressed against the inner cell components in normal pressure conditions (1000 mbar). The greater the difference between the internal pressure in the cell and the external pressure, the higher is the contact pressure of the composite sheet, which forms the housing material, against the cell interior. If the internal pressure in the cell is equal to or greater than the external pressure, this leads to fluttering or even inflation of the metal/plastic composite sheet.

Various problems can occur before, during or after the production of the cell. For example, leaks can occur as a result of small holes in the composite sheet. The gas may not be satisfactorily removed from the cell after the formation process, or a leak may occur as a result of faulty sealing during the final sealing process. Leaks can also occur as a result of faults in the sealing layer or as a result of a gas formation in the cell resulting from production faults such as an internal leak or short circuit.

Known methods for testing cells in a softpack or in a thin-walled flexible housing for problems and leaks such as these are time-consuming and costly.

For example, attempts have been made to verify faults such as these by reweighing a cell after a defined storage time at a raised temperature. However, only a sample check is feasible in this case, since the cells are irreversibly damaged by a method such as this.

Further methods comprise the use of light and a light sensor to check for fault points or holes in the thermoformed metal/plastic composite sheet, even before use as a housing component. However, this finds only very large holes with diameters of at least 10 μm. Holes or gassing that occur later in the complete cell cannot be checked in this way.

In addition, it is possible to detect gaseous volatile electrolyte components by means of a mass spectrometer. However, this is also fairly complex and only a sample check is feasible.

Manual visual examination, with the goal of checking whether the metal/plastic composite sheet is in place and forming a seal, is likewise complex and not adequate, since holes in the housing material or in the sealing layer cannot be checked. Automatic visual examination, for example, by means of an image processing system, in order to verify whether the metal/plastic composite sheet is in place and forming a seal, is not feasible on a reliable process basis, since the aluminium composite sheet is highly reflective, so that only highly inflated cells can be identified. Furthermore, a check such as this does not allow holes in the softpack or in the sealing layer to be checked.

By way of example, JP 11307136A1 discloses an apparatus for leak testing for welded battery housings by means of a differential pressure measurement, and JP 9115555 describes a method and apparatus for leak testing of batteries by evaluation of a pressure change.

It would therefore be advantageous to provide a way of carrying out a leak test in a simple and rapid manner on electrochemical elements which have a thin flexible housing that is composed of a metal sheet or metal/plastic composite sheet, with the check covering leaks, inadequate gas removal and subsequent gas development. It would also be advantageous to provide a method that can be integrated in the production process of the cell without additional complex process steps being required for this purpose.

### SUMMARY OF THE INVENTION

This invention relates to a method for leak testing of an electrochemical element which has a thin flexible housing that is composed of a metal sheet or a metal/plastic composite sheet including, after assembly and formation of the element in a closed container, subjecting the electrochemical element to an increased pressure and then to a reduced pressure, and measuring any change in thickness that occurs.

This invention also relates to a method for leak testing of an electrochemical element which has a thin flexible housing that includes a metal sheet or a metal/plastic composite sheet including, after assembly, formation and storage of the element in a closed container, subjecting the electrochemical element to a reduced pressure, and measuring change in thickness that occurs.

### BRIEF DESCRIPTION OF THE DRAWING

The sole FIGURE is a schematic front elevational view of testing apparatus in accordance with aspects of the invention.

### DETAILED DESCRIPTION

According to aspects of the invention, one or more cells are inserted, for example, into a tray in the softpack in a container which is stable in a vacuum and, optionally, is stable in increased pressure as well. A measurement system for determination of the cell height is provided in the container. Light barriers, laser reflection, pressure switches and inductive or capacitive height measurement sensors are used, for example, for measurement of the cell height.

After vacuum sealing the softpack, the cells are optionally measured directly after the activation with electrolyte and before formation, or after formation in this container. Two procedures are preferred and are explained in the following text with reference to a cell which has been formed completely and has then had the gas removed.

In a first embodiment, the cell is tested directly after formation, gas removal and vacuum sealing. The cell is subjected to an increased pressure in the range from about 1 to about 10 bar (absolute) for a short period of time in the softpack in the container. During this time, air is forced into the softpack through any holes that may be present. A defined reduced pressure (vacuum down to about 500 mbar absolute) is then applied substantially immediately. The cell height is measured throughout the entire time period, for example, by means of one of the methods mentioned above, and changes are recorded. The height measurement is in this case carried out in particular using a non-contacting measurement method.

In a further refinement, the cell is tested after formation, after vacuum sealing and after a lengthy storage time. The measurement is carried out in the same way as in the first embodiment, although the step of subjecting the cell to increased pressure can be omitted since it has already been possible for air to diffuse into the cell through any hole(s) in the cell housing, as a result of the lengthy storage.

If the cell does not inflate when the vacuum is applied (internal pressure < external pressure), no height difference is measured, that is to say the cell is sealed correctly and, as before, contains the reduced pressure produced during the vacuum sealing process.

If the cell inflates when the vacuum is applied (internal pressure > external pressure), the height measurement indicates a change, namely an increase in the cell thickness. This may be because the gas has not been removed adequately from the cell during the vacuum sealing process, so that there was never an optimum vacuum in the cell, or the cell has formed gaseous deposition products after the vacuum sealing process, for example, as a result of a leak or as a result of electrochemical decomposition, so that the vacuum in the cell has been at least partially depleted.

Another possibility is for the composite sheet which is used as a packaging material for the cell components to be leaky as a result of holes or poor processing, as a result of which the vacuum is depleted or disappears gradually as a result of air flowing in. A further possibility is for the sealing material to be faulty or for the sealing process to have been carried out incorrectly, so that the vacuum is gradually depleted or disappears as a result of air flowing in.

The FIGURE shows, schematically, an apparatus for carrying out the method according to the invention. The cell in the softpack 5 is arranged in the pressure container 4. The pressure container is on the one hand provided with a compressed air connection 1, a vacuum connection 2 and appropriate valves 3. Furthermore, the container 4 has a pressure indicator 6 (manometer) and a system 7 for measurement of the cell height.

1. A method for leak testing of an electrochemical element which has a thin flexible housing that is composed of a metal sheet or a metal/plastic composite sheet comprising, after assembly and formation of the element in a closed container, subjecting the electrochemical element to an increased pressure and then to a reduced pressure, and measuring any change in thickness that occurs.

2. The method according to claim 1, wherein the increased pressure is between about 1 and about 10 bar (absolute).

3. The method according to claim 1, wherein the increased pressure is between about 4 and about 8 bar (absolute).

4. The method according to claim 1, wherein the reduced pressure is between about 0 and about 500 mbar (absolute).

5. The method according to claim 1, wherein the change in thickness is measured by a non-contacting measurement method.

6. A method for leak testing of an electrochemical element which has a thin flexible housing that comprises a metal sheet or a metal/plastic composite sheet comprising, after assembly, formation and storage of the element in a closed container, subjecting the electrochemical element to a reduced pressure, and measuring change in thickness that occurs.

7. The method according to claim 6, wherein the reduced pressure is between about 0 and about 500 mbar (absolute).

8. The method according to claim 6, wherein the change in thickness is measured by a non-contacting measurement method.
